(19) United States
(12) Patent Application Publication
(10) Pub. No.: US 2013/0322200 A1
(43) Pub. Date: Dec. 5, 2013

(54) SAMPLING METHOD AND DEVICE

(71) Applicant: Andreas LUDWIG, Starnberg (DE)

(72) Inventor: Andreas LUDWIG, Starnberg (DE)

(21) Appl. No.: 13/900,117

(22) Filed: May 22, 2013

(30) Foreign Application Priority Data
May 31, 2012 (DE) 10 2012 104 708.1

(51) Int. Cl. G01N 1/28

(52) U.S. Cl. CPC G01N 1/286
USPC 366/108; 73/864.11

(57) ABSTRACT

A method and a device for taking a sample from a vessel are described. A section of a sample collector is set into a controlled oscillation, in order to monitor a change in the oscillatory behavior about contact of the sample collector with a liquid to be picked up or another component, and to achieve better thorough mixing of the sample by means of the oscillation.

### FIELD OF THE INVENTION

The present invention relates to a method for taking a sample, in particular of a liquid from a vessel, and to a sample collector for implementing the method.

### BACKGROUND

Laboratory work is familiar with the problem of removing liquids from containers, in order to supply them to a chemical analysis, for example. This is frequently done with the aid of automatic pipettes, in which a sample collector is dipped into the liquid (sample) in order to pick up or suck up a specific quantity thereof from the sample storage vessel. The sample taken in this way can then be supplied to the chemical analysis or another determination.

The movement of the control of the sample collector has proven to be a problem. The often automated movement of the sample collector, which normally picks up the sample via a quite thin and sensitive suction needle, must be carried out in such a way that the needle dips sufficiently deeply into the liquid in order to be able to suck up the liquid. At the same time, however, collision with other components must be prevented in order to prevent damage to the needle or to the mechanism moving the needle. Furthermore, unnecessarily deep dipping is to be avoided, since this leads to undesired carry-over of one sample to the next. In the prior art, the detection of the sample surface is carried out capacitively or by means of conductivity measurements. In this case, however, the electrical properties of the sample and of the sample collector are of great significance and surfaces of non-conductive samples or liquids cannot be detected. In addition, sample collectors made of non-conductive material (e.g. fused silica) cannot be used for this purpose. Furthermore, during detection by means of conductivity measurement, an additional electrode has to dip into the sample, which increases the complication further.

In order to avoid needle obstructions, i.e. collisions with undesired components, in the prior art a spring mounting of the sample collector or the needle is chosen. In addition, light barriers for the detection of threatening collisions are employed. The additional expenditure for design and control is considerable in this case.

Furthermore, there is the problem of avoiding de-mixing of the sample in the sample vessel, in order to be able to rule out erroneous analytical results based on de-mixing. To this end, in the prior art the sample vessel is shaken. However, in the case of low vessel volumes, shaking is ineffective, very frequently a high number of very small vessels being employed simultaneously, which then have a width of only 1.7 mm, for example.

In addition, it is necessary to avoid sample residues remaining adhering to the sample collector or the needle thereof. They could dry thereon and contaminate a further sample to be taken later and therefore exert an undesired influence on the analytical result.

### SUMMARY

A method for handling of a liquid in a vessel with a sample collector is described. The method includes oscillating at least one section of the sample collector where the sample collector is not in contact with the liquid or the vessel, the oscillating having an amplitude and a frequency. Next, the sample collector can be lowered in a direction of a surface of the liquid while the at least one section is oscillating. The liquid can be mixed with the sample collector in the vessel while the at least one section is oscillating. A sample from the vessel can be sucked with the sample collector.

In regards to the above method, it can further include monitoring the amplitude or the frequency of the sample collector. A first change in the amplitude or the frequency can be detected when the sample collector contacts the surface of the liquid.

In regards to the above method, it can further includes after detecting the first change, stopping the lowering of the sample collector once a predefinable minimum dipping depth is reached.

In regards to the above method, it can further include detecting a second change in the amplitude or the frequency when the sample collector contacts a surface of the vessel or a solid component.

In regards to the above method, the sample collector includes an excitation element configured to oscillate the at least one section of the sample collector. The excitation element may also be configured to monitor the amplitude or the frequency of the sample collector. The excitation element may be a piezoelectric element, an electromagnet, an electrodynamic coil/magnet system, or a mechanical imbalance.

In regards to the above method, it can further include removing adhering substances from the sample collector while the at least one section is oscillating when the sample collector is outside of the liquid.

In regards to the above method, the vessel can be closed with a septum. The method further includes before the lowering of the sample collector, piercing through the septum with a tube, in which the lowering of the sample collector is within the tube and the sample collector does not touch the septum.

In regards to the above method, it can further include discharging the sample to an analysis station.

A sample collector configured to suck a liquid from a vessel is described. The sample collector includes a needle, an excitation element, a sensor element, and an evaluator. The excitation element can oscillate at least one section of the needle at an amplitude and a frequency. The sensor element can monitor the amplitude or the frequency of the needle. The evaluator can detect a change in the amplitude or the frequency of the needle.

In regards to the above sample collector, the excitation element may be a piezoelectric element, an electromagnet, an electrodynamic coil/magnet system, or a mechanical imbalance. The sensor element may be a piezoelectric element, an optical sensor, or a magnetic sensor. In an embodiment, the sensor element and the excitation element may be combined together.

In regards to the above sample collector, the sample collector includes a tube configured to pierce a septum where the vessel is closed with the septum, the needle being located within the tube. The tube may be beveled to cut into the septum.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1 illustrates a sample collector during a laboratory application in different positions where the sample collector is in contact with air, a liquid, or a solid component.

### DETAILED DESCRIPTION OF EMBODIMENTS

The object of the invention was therefore to offer a method for reliable and simplified handling of a liquid provided for sampling, which is also able to improve the quality of the analytical results while avoiding the aforementioned disadvantages.

The invention is based on the finding, by means of a sample collector set to oscillate, not only to be able to determine easily the contact of the sample collector with a liquid or other components but also to be able to use the vibratory movement of the sample collector for thorough mixing of the sample and for shaking off contamination, in order to be able to improve the quality of the sample taken and the subsequent analysis. Therefore, the method according to the invention at the same time and in a simple way solves a number of problems known from the prior art and therefore makes separate means for the detection of needle obstructions (light barriers, etc.) unnecessary and creates a simple and reliable method for the detection of the sample surface. The design structure of the vessel holders is simplified, since these no longer have to be shaken and, in addition, means for the separate drying of the sample collector can be dispensed with, according to the invention.

The sample collector which can be dipped into the liquid and in which at least one section is set to oscillate, effects thorough mixing of the liquid in the vessel by means of the oscillation or vibration thereof, so that a homogenous sample can be removed or sucked up from the vessel. Outside the liquid, the oscillation of the vibrating section effects the shaking of undesirably adhering substances, which facilitates or renders superfluous additional cleaning of the sample collector and therefore improves the quality of the analysis.

If the oscillation of the sample collector is monitored for a change in its frequency and/or amplitude, then the making of contact of the sample collector with the liquid or another component can be determined therefrom, since frequency and/or amplitude change as a result of such a contact. For instance, the frequency of the needle of the sample collector that is set to oscillate will change at the instant in which it dips into the liquid out of the air above the liquid level. The cause is, amongst other things, the changing density and viscosity. If this change is monitored with the aid of a suitable evaluation unit, if necessary taking predefinable tolerances into account, then it is easily possible to detect when the sample collector has been lowered sufficiently far and dipped into the liquid of the sample vessel in order to be able to suck in a sample. With the dipping in the sample, at the same time desirable thorough mixing of the liquid results, which results from the movement of the sample collector or the needle of the sample collector, resulting from the oscillation, relative to the vessel and the liquid in the vessel. As distinct from the prior art, in this way even rather small sample vessels can be thoroughly mixed very well. According to the invention, the frequency and/or amplitude of the oscillation can be chosen such that, firstly, the best possible thorough mixing, secondly the highest possible suitability for the detection of frequency and/or amplitude changes are present.

A further advantageous aspect of the invention resides in the fact that, by monitoring the frequency and/or amplitude of the section of the sample collector that is set to oscillate, it is also possible to detect whether this section collides with an obstacle during the movement of the sample collector. Thus, for example, it is possible to ensure that the needle of the sample collector is not lowered too deeply into the sample vessel, specifically as far as the bottom of the vessel, as a result of which the needle could suffer damage. In addition, the undesired contact of the sample collector or the suction needle thereof with the wall of the vessel or another, preferably fixed or solid component, can easily be detected in this way and taken into account immediately in the control for the movement of the sample collector. The invention makes use of the phenomenon that making contact between the section of the sample collector set to oscillate and a solid body (vessel wall, laboratory bench, etc) leads to a different frequency or amplitude change than would be the case in the event of contact with the liquid to be sucked up. Depending on the type of change occurring, it is therefore possible to establish whether the sample collector is merely dipping into the liquid or colliding with a (possibly fixed) solid body. In the latter case, the preferably automatically controlled movement of the sample collector can be stopped immediately or possibly even reversed, in order to eliminate the collision and to minimize damage.

Furthermore, the method according to the invention also permits the determination as to whether liquid can be removed with the sample collector from the sample vessel at all. If, for example when lowering the sample collector from a region above a supposedly present liquid level into the region underneath the supposed liquid level, the expected frequency or amplitude change does not result, this points to the fact that there is no or too little sample liquid present. If the result is even a frequency or amplitude change which permits a conclusion to be drawn about contact with a solid component, this would be an indication of a collision with the vessel bottom without a frequency or amplitude change typical of liquid contact having previously occurred. This then likewise points to an empty vessel.

Following removal of the sample from the vessel and, in particular, following discharge of the sample for further analysis, the oscillation (generated again following an interruption or introduced unchanged) of the sample collector can be used to shake off contaminants adhering to the sample collector or the suction needle thereof. This facilitates or renders superfluous the cleaning of the sample collector and prevents erroneous analyses of further samples taken subsequently. The drying of the sample collector can be achieved without the components (air pump, air supply) additionally required in the prior art.

In order to transfer the oscillation to the first section of the sample collector, a suitable excitation element, in particular a piezoelectric element, an electromagnetic or an electrodynamic coil/magnet system or else a mechanical imbalance is suitable. The measurement of the frequency and/or the amplitude of the oscillating section of the sample collector can likewise be carried out by means of a piezoelectric element or else by an optical or magnetic sensor. Further sensors, familiar to those skilled in the art, for determining a frequency and/or amplitude of oscillation are likewise suitable for this purpose.

The oscillation can be excited in different ways. The excitation element must be driven in such a way that the resultant oscillation depends as highly as possible on the mechanical conditions on the sample collector, in particular liquid or solid body contact. One simple possible way is to excite with a fixed frequency and merely to evaluate the resultant amplitude of oscillation. This method can be improved by the excitation frequency being varied in a specific range and resonant frequencies being determined by measuring the respective amplitude. Alternatively, the oscillation can also be excited in pulse form and the transient behavior evaluated. One further possible way is the implementation of a self-oscillating system by means of feeding the sensor signal back to the excitation. In this case, frequency and/or amplitude can be evaluated.

Depending on the type of excitation element used, it can be a particular advantage when the excitation element is used as a sensor element at the same time. For example, a piezoelectric element that is set to oscillate mechanically outputs a corresponding voltage, that has a frequency and amplitude of oscillation, which can be determined. In a manner analogous to this, an oscillation can also be both excited and analyzed via an electrodynamic system. By using such a combined excitation/sensor element, a self-oscillating system can also be implemented very simply, by this being wired as a frequency-determining component of an electronic oscillator circuit.

If the sample collector collides with a solid body, this generates a signal in the sensor element or combined excitation/sensor element even when the sample collector is not set to oscillate or the oscillation has already decayed. Thus, a collision can also be detected without any excitation of oscillation.

In practice, the vessels with the samples are frequently closed by a membrane (septum), through which a needle as sample collector must temporarily be stuck in order to remove liquid. Since the needle touches the membrane, the oscillations of the needle according to the invention would be damped and detection in the sense of the above description would be difficult or impossible. An advantageous embodiment of the invention therefore provides for a pre-piercer to be used, which penetrates the membrane temporarily before the sample removal, in an area which is larger than the cross section of the needle or of the sample collector. A needle lowered into the vessel within the pre-piercer then consequently does not touch the membrane and can be oscillate without hindrance. One simple form of the pre-piercer comprises a small tube which, in its longitudinal direction, is forced a short distance through the resilient membrane, so that the membrane touches and encloses the small tube along the outer circumference of the tube. The free internal cross section of the small tube then permits the sample collector to be lowered through the small tube into the vessel and the liquid, without the membrane (or the small tube) being touched in the process. Such a pre-piercer is known per se. Unknown, on the other hand, is its use for a vibrating needle in order to avoid contact of the membrane with the needle, and thus to prevent any undesired influence on the oscillation of the needle by the membrane.

In order to make the penetration of the membrane by means of small tubes easier, the foremost section of the tube can be beveled, in order to cut into the membrane in a defined manner. In addition, a cross-member carrying the small tube can be used to fix the vessel stably subsequent to the piercing of the membrane and during the removal of the sample.

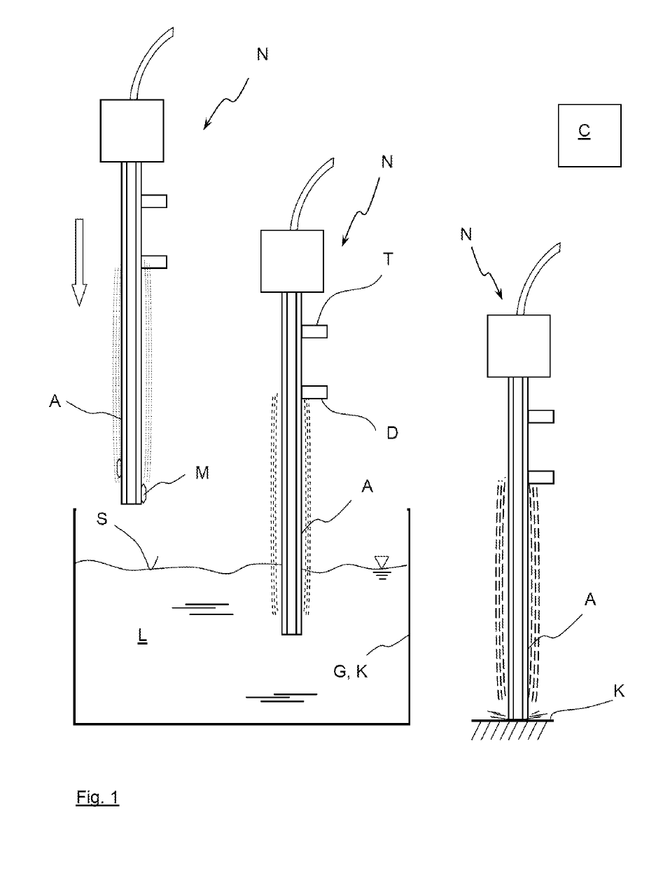

An embodiment of the method according to the invention and of the corresponding sample collector is to be explained in more detail by FIG. 1, which shows a sample collector during a laboratory application in different positions.

The sample collector N illustrated in the left-hand part of FIG. 1 is used to pick up a liquid L from a vessel G containing the liquid L. In the container G, the liquid L forms a surface S, through which the sample collector N has to be lowered in order to be able to remove a sample from the liquid L.

For this purpose, the sample collector has a downwardly directed channel in the form of a needle, part of the needle being designated section A. This section A can be excited to oscillate by an excitation element T arranged on the sample collector N. A sensor D likewise arranged on the sample collector is used for the purpose of measuring the frequency and/or amplitude of the oscillation introduced into the needle and the section A. Excitation element T and sensor D are connected to a control and evaluation unit C, which also controls the movement of the sample collector via a mechanism (for example, robotic) not specifically illustrated.

The method according to the invention proceeds as follows:

The sample collector N is firstly, as illustrated in the left-hand part of FIG. 1, positioned above the vessel G, without initially making contact with the liquid or another component. Before or during the subsequent lowering of the sample collector N in the direction of the surface S of the liquid L, the excitation element T is excited to produce a predefinable oscillation, which in particular sets the section A of the sample collector oscillating. Frequency and/or amplitude at which the section A oscillates is monitored by the sensor D and signaled to the control unit C.

When the lower section A of the sample collector N reaches the surface S of the liquid L, the frequency and/or amplitude of the section A changes, which the control unit C (depending on the type of frequency or amplitude change) will interpret as the section A dipping into the liquid L. The downward movement of the sample collector N can be stopped—if necessary after a predefinable minimum dipping depth has been reached—in order to suck liquid L into the sample collector N at this depth. In addition, the dipping depth can be determined by monitoring the frequency and/or amplitude of the section A, since these values likewise change with increasing dipping depth. Via an allocation table stored in the control unit, a specific dipping depth could thus be assigned to a specific frequency and/or amplitude. In the center of FIG. 1, the position of the sample collector N after the desired dipping depth has been reached is shown.

Following removal of the desired quantity of liquid from the vessel G, the sample collector N can be moved upward out of the liquid L, after which the liquid removed can be supplied to an analysis station, not illustrated, in order to discharge said sample there. Then, the (continuously maintained or connected up after an interruption) oscillation is capable of shaking off contaminants M possibly adhering to the section A, in order as a result to clean the sample collector N relatively simply.

The illustration on the extreme right in FIG. 1 shows the sample collector N if—instead of dipping into the liquid L—it is inadvertently lowered onto a component K until the section A comes into contact with this component K. In this case, the frequency and/or amplitude of the oscillation of the section A measured by the detector D also changes, but in a different way than in the case of the contact with the liquid L. Starting from the “contact-less” oscillation of the section A, as shown in the left-hand part of FIG. 1, the oscillatory behavior of the section A changes differently, depending on the medium L or the component K respectively contacted, as is intended to be indicated by the differently sketched vibration in the individual illustrations of the section A of the sample collector N in FIG. 1. Therefore, depending on the change in the oscillation that occurs, as compared with the initial situation illustrated on the extreme left, the evaluation unit C is capable of determining the contact with the liquid L or a generally undesired contact with a stationary or solid component K, the latter also including the wall of the vessel G.

What is claimed is:

1. A method for handling of a liquid in a vessel with a sample collector, the method comprising:
oscillating at least one section of the sample collector where the sample collector is not in contact with the liquid or the vessel, the oscillating having an amplitude and a frequency;
lowering the sample collector in a direction of a surface of the liquid while the at least one section is oscillating;
mixing the liquid with the sample collector in the vessel while the at least one section is oscillating; and
sucking a sample from the vessel with the sample collector.

2. The method of claim 1 further comprising:
monitoring the amplitude or the frequency of the sample collector; and
detecting a first change in the amplitude or the frequency when the sample collector contacts the surface of the liquid.

3. The method of claim 2 further comprising:
after detecting the first change, stopping the lowering of the sample collector once a predefinable minimum dipping depth is reached.

4. The method of claim 2 further comprising:
detecting a second change in the amplitude or the frequency when the sample collector contacts a surface of the vessel.

5. The method of claim 2 further comprising:
detecting a second change in the amplitude or the frequency when the sample collector contacts a solid component.

6. The method of claim 1, in which the sample collector comprises an excitation element configured to oscillate the at least one section of the sample collector.

7. The method of claim 6, in which the excitation element is also configured to monitor the amplitude or the frequency of the sample collector.

8. The method of claim 6, in which the excitation element is selected from the group consisting of a piezoelectric element, an electromagnet, an electrodynamic coil/magnet system, and a mechanical imbalance.

9. The method of claim 1 further comprising:
removing adhering substances from the sample collector while the at least one section is oscillating when the sample collector is outside of the liquid.

10. The method of claim 1, in which the vessel is closed with a septum, the method further comprising:
before the lowering of the sample collector, piercing through the septum with a tube, in which the lowering of the sample collector is within the tube and the sample collector does not touch the septum.

11. The method of claim 1 further comprising:
discharging the sample to an analysis station.

12. A sample collector configured to suck a liquid from a vessel, the sample collector comprising:
a needle an excitation element to oscillate at least one section of the needle at an amplitude and a frequency;
a sensor element to monitor the amplitude or the frequency of the needle; and
an evaluator to detect a change in the amplitude or the frequency of the needle

13. The sample collector of claim 12, in which the excitation element is selected from the group consisting of a piezoelectric element, an electromagnet, an electrodynamic coil/magnet system, and a mechanical imbalance

14. The sample collector of claim 12, in which the sensor element is selected from the group consisting of a piezoelectric element, an optical sensor, and a magnetic sensor

15. The sample collector of claim 12, in which the sensor element and the excitation element are combined together.

16. The sample collector of claim 12 further comprising a tube configured to pierce a septum where the vessel is closed with the septum, the needle being located within the tube.

17. The sample collector of claim 15, in which the tube is beveled to cut into the septum.
